(19) United States
(12) Patent Application Publication
(10) Pub. No.: US 2016/0339445 A1
(43) Pub. Date: Nov. 24, 2016

(54) RECYCLING SYSTEMS AND METHODS OF RECYCLING

(71) Applicant: TCHAD ROBINSON, West Hollywood, CA (US)

(72) Inventor: TCHAD ROBINSON, West Hollywood, CA (US)

(21) Appl. No.: 15/228,701

(22) Filed: Aug. 4, 2016

Related U.S. Application Data
(60) Provisional application No. 62/201,286, filed on Aug. 5, 2015.

(51) Int. Cl. B02C 23/14; B07C 5/342; B03C 7/08; B07B 9/02

(52) U.S. Cl. CPC B02C 23/14; B07B 9/02; B07C 5/3425; B03C 7/08

(57) ABSTRACT

Systems and methods for liberating materials of interest from an item, and sorting those materials. Systems and methods may separate shredded material of an item into shredded material that contains ferrous metal, and remaining shredded material, and sort the remaining shredded material into fine material, light material, and heavy material. Systems and methods may separate the heavy material into heavy material that contains ferrous metal and remaining heavy material, separate the light material into light material that contains ferrous metal and remaining light material, and sort the remaining light material into at least a first type of remaining light material and a second type of remaining light material.

### FIELD

Systems and methods for liberating and sorting materials of interest from an item are described. Certain embodiments pertain to recycling systems and methods for liberating and sorting materials of interest from mattresses and box-springs.

### BACKGROUND

Safe and cost-effective disposal and recycling of materials, such as mattresses and box-springs, is a huge logistical, technological, and environment challenge for local, county, and state governments in the United States, and for many countries around the world. Due to their physical size and weight, mattress and box-springs are difficult and costly to transport and handle. Moreover, their relatively complex physical and material structure means that many traditional automated or semi-automated recycling technologies cannot be used, or are simply uneconomical, especially if used to process relatively low quantities. Manual processing of mattresses and box-springs is also costly and slow, and can ultimately result in a significant quantity of material waste that requires disposal through incineration or within a landfill. It is estimated that about one bale of non-recyclable material is produced from every 150 mattresses recycled using traditional recycling techniques. Clearly, systems and methods that solve the above problems are needed.

### SUMMARY

This disclosure relates generally to systems, methods, machine-readable media and means for liberating and sorting materials of interest from an item. Such systems, methods, machine-readable media and means may: separate shredded material of an item into shredded material that contains ferrous metal and remaining shredded material; sort the remaining shredded material into fine material, light material, and heavy material; separate the heavy material into heavy material that contains ferrous metal and remaining heavy material; separate the light material into light material that contains ferrous metal and remaining light material; and sort the remaining light material into at least a first type of remaining light material and a second type of remaining light material.

### BRIEF DESCRIPTION OF THE DRAWINGS

FIG. 1 depicts a system for liberating and sorting materials of interest from an item that is input into the system.

FIG. 2 illustrates a process for liberating and sorting materials of interest.

FIG. 3A depicts stages for shredding material and separating metal using a system for liberating and sorting materials of interest.

FIG. 3B depicts stages for sorting materials based on size, weight and/or density, and for separating metal using a system for liberating and sorting materials of interest.

FIG. 3C depicts a stage for sorting light materials using a system for liberating and sorting materials of interest.

FIG. 4A illustrates functional details of material shredding and metal separation processes.

FIG. 4B illustrates functional details of size, weight and/or density sorting and metal separation processes.

FIG. 4C illustrates functional details of a light material sorting processes.

### DETAILED DESCRIPTION

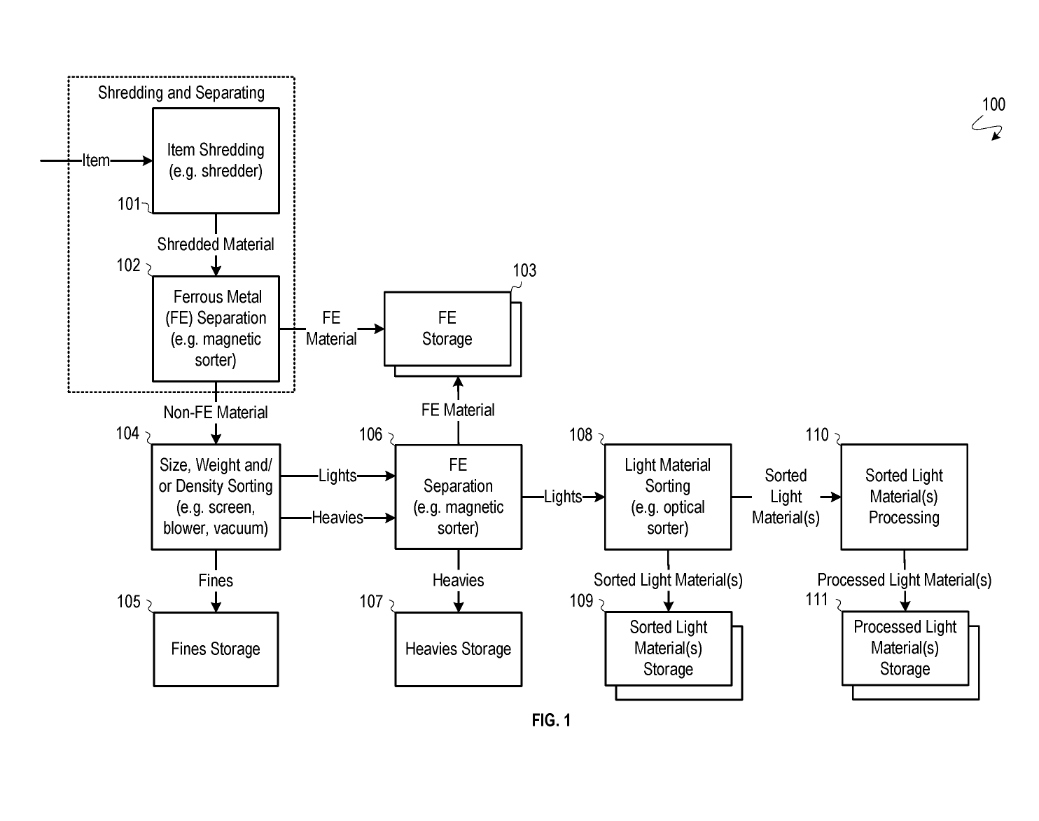

Attention is initially drawn to FIG. 1, which depicts a system for liberating and sorting materials of interest from an item that is input into the system. Materials of interest may differ depending on different embodiments. By way of example, such materials of interest may be liberated and sorted from mattresses and/or box-springs. In alternative embodiments, the materials of interest may be liberated and sorted from other items (e.g. furniture, vehicles, or other items formed using different materials of interest).

As shown, the system depicted in FIG. 1 includes: a material shredding module 101 (e.g. an industrial material shredder); a ferrous metal (“FE”) separation module 102 (e.g. a magnetic sorter); an FE storage module 103; a size, weight and/or density sorting module 104 (e.g. a screen, blower, vacuum, etc.); a fines storage module 105; an additional FE separation module 106; a heavies storage module 107; a light material sorting module 108 (e.g. an optical sorter); a sorted light material(s) storage module 109; a sorted light material(s) processing module 110 (e.g. an HDPE granulator); and a processed light material(s) storage module 111. As shown, the material shredding module 101 and the FE separation module 102 could form a “shredding and separating” module. Details of each of the above modules are described below in further detail.

The material shredding module 101 is positioned to receive incoming items, and is coupled to the FE separation module 102. The FE separation module 102 is coupled to the FE storage module 103 and the size, weight and/or density sorting module 104. The size, weight and/or density sorting module 104 is coupled to the fines storage module 105 and to the additional FE separation module 106. The additional FE separation module 106 is coupled to the FE storage module 103, to the heavies storage module 107 and to the light material sorting module 108. The light material sorting module 108 is coupled to the sorted light material(s) storage module 109 and to the sorted light material(s) processing module 110. The sorted light material(s) processing module 110 is coupled to the processed light material(s) storage module 111. Material is transported between modules by various means, including conveyors, vibrating conveyors, transportable bins, or other means.

The material shredding module 101 is operable to receive one or more items, and to shred or otherwise separate the item(s) into material of a size sufficient to liberate metal from most fabrics and other materials, as well as liberating other materials of interest (e.g. foam, wood, quilting, fabric, HDPE etc.). The FE separation module 102 is operable to separate material with FE from the shredded material. The FE storage module 103 is operable to store separated FE. The size, weight and/or density sorting module 104 is operable to sort materials by size, weight and/or density (e.g. into fine, light and heavy material). The fines storage module 105 is operable to store separated fine material. The additional FE separation module 106 is operable to separate materials FE from light material (“lights”) and heavy material (“heavies”). The heavies storage module 107 is operable to store heavy material. The light material sorting module 108 is operable to identify and sort materials of interest within the light material. The sorted light material(s) storage module 109 is operable to store the sorted materials of interest. The sorted light material(s) processing module 110 is operable to further process sorted materials of interest (e.g. granulate HDPE). The processed light material(s) storage module 111 is operable to store processed light materials.

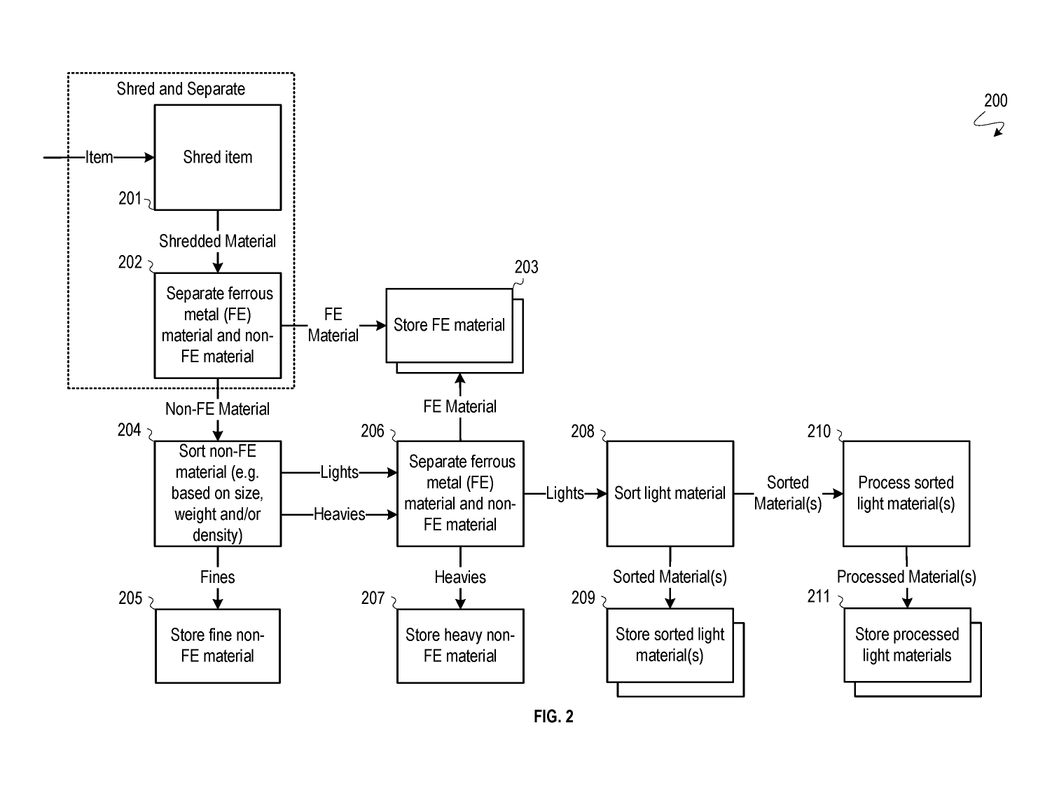

Attention is now drawn to FIG. 2, which illustrates a process for liberating and sorting materials of interest (e.g. using the system of FIG. 1). As shown, steps of the process include: shredding an item (step 201); separating the shredded item into material with ferrous metal (“FE”) and “non-FE” material (step 202); storing the separated FE material (step 203); sorting the non-FE material (e.g. based on size, weight and/or density) into “fines”, “lights” and “heavies” (step 204); storing the fine non-FE material (step 205); separating FE material and non-FE material from the lights and heavies (step 206) (storing separated FE according to step 203); storing the heavy non-FE material (step 207); sorting the light material (step 208); storing one or more of the sorted light material(s) (step 209); processing one or more of the sorted light material(s) (step 210); and storing the processed light material(s) step 211.

“Non-FE” material, as discussed herein, may include material free of FE, material with trace amounts of FE, or material with a tolerated amount of FE depending on the stage at which the particular non-FE material is created. For example, material with a tolerated amount or trace amounts of FE may be sorted at stage 204, and material with trace amounts of FE or free of FE may be separated at stage 206. A tolerated amount of FE may include any amount of FE that can be removed at a later stage.

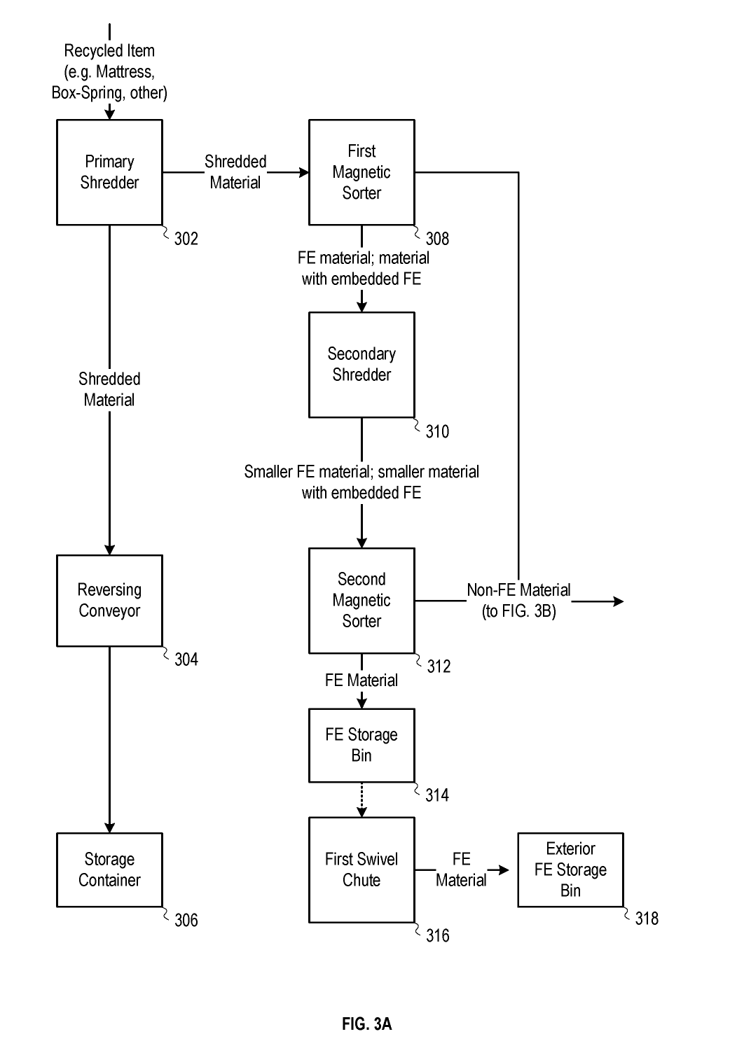

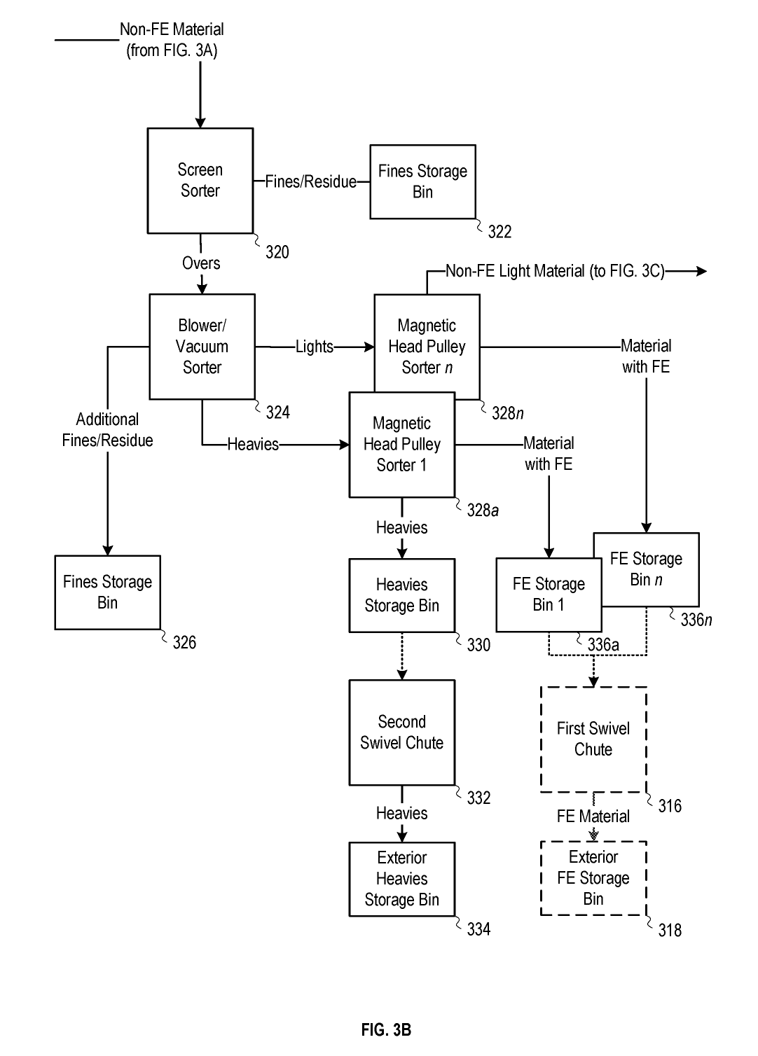

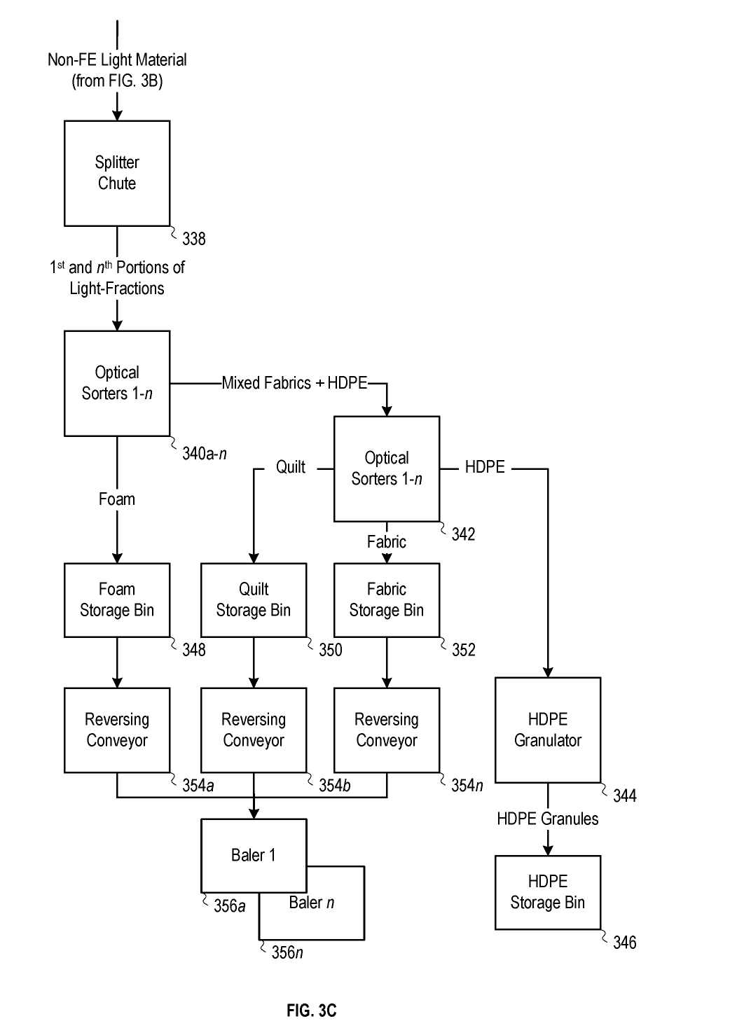

Attention is now drawn to FIG. 3A, FIG. 3B and FIG. 3C, which depict different aspects of the system 100 shown in FIG. 1 when the system 100 is used to recycle a mattress and/or a box spring. It is noted that different embodiments of FIG. 1 need not use each aspect shown in FIG. 3A, FIG. 3B and FIG. 3C.

FIG. 3A depicts details of stages for shredding material and separating metal using a system for liberating and sorting materials of interest. FIG. 3A depicts various devices, including: a primary shredder 302; a reversing conveyor 304; a storage container 306; a first magnetic sorter 308; a secondary shredder 310; a second magnetic sorter 312; a ferrous metal (“FE”) storage bin 314; a first swivel chute 316; and an exterior FE storage bin 318.

The primary shredder 302 is positioned to receive one or more items, and is coupled to the reversing conveyor 304 and to the first magnetic sorter 308. The reversing conveyor 304 is coupled to the storage container 306. The first magnetic sorter 308 is coupled to the secondary shredder 310 and to a screen sorter 320 (see FIG. 3B). The secondary shredder 310 is coupled to the second magnetic sorter 312. The second magnetic sorter 312 is coupled to the FE storage bin 314 and to the screen sorter 320 (see FIG. 3B). The FE storage bin 314 is coupled to the first swivel chute 316. The first swivel chute 316 is coupled to the exterior FE storage bin 318. Material is transported between devices by various means, including conveyors, vibrating conveyors, transportable bins, or other means.

The primary shredder 302 is operable to shred or otherwise separate incoming items into strips or pieces of material that are small enough to liberate different types of material (e.g. metal, foam, quilting, wood, etc.) from one another, yet are still large enough that the strips and pieces may be manipulated using downstream system modules to sort and separate constituent materials of interest. In different embodiments, the primary shredder 302 rips the incoming material into pieces having at least one dimension of 6 inches or 9 inches. Of course, other dimensions can be used as required by the application of the system.

In some embodiments, the primary shredder 302 can utilize a quad-shear shredder with a screen for restricting material particles of certain sizes from passing through. Materials can be shredded and recirculated until the material particles are small enough to fit through the screen. In some embodiments, the uniformity of particle sizes afforded by the use of the screen can allow for greater efficiency in separation techniques downstream of the primary shredder 302. Specifically, with mattress and box spring materials, the size of the metal and wood shred can be driven by the width of the shredder's cutters, and can include a covering of the center row of apertures in the shredder's screen to avoid wood “spears” from shooting through the middle shafts of the shredder and directly through an aperture while the size of various foam, fabric and fiber materials can be driven by the size of apertures in the shredder's screen. Cutters with a width of about two inches can be sufficient to liberate most metal from wood and fabrics in mattresses and box-springs, while being large enough to generate the force needed to shred and provide desired throughput capacity.

Once the incoming material is shredded into pieces of material that are mostly separate from each other, downstream system modules are used to focus on the different characteristics of the shredded material to sort/separate each of the different materials of interest from the shredded material stream. The system advantageously permits particular materials that have value to be separated from materials that have less value.

As the stream of shredded material leaves the primary shredder 302, material can be removed by the reversing conveyor 304, which deposits the removed material in the storage container 306. Material may otherwise pass under the first magnetic sorter 308, which is operable to extract ferrous metal (“FE material”) from the shredded material stream. In one embodiment, the first magnetic sorter 308 is a suspended overhead cross-belt magnet that “picks up” anything in the material stream that is FE material, or anything that is attached to FE material, and carries this material to another conveyor which leads to the secondary shredder 310. The remaining stream of shredded material constituting material that was not picked up by the first magnetic sorter 308 can have 95% of the FE material removed at this stage.

The secondary shredder 310 is operable to further shred or otherwise separate the material that was picked up by the first magnetic sorter 308 in order to reduce that material into smaller pieces. In some embodiments, this reduction is performed in order to break the coils of mattresses and box springs, and to liberate any FE material that was attached to non-FE material. As the shredded FE material stream exits the secondary shredder 310, the FE material passes under the second magnetic sorter 312.

The second magnetic sorter 312 is operable to extract FE material from the shredded material stream and transfer the extracted FE material to yet another conveyor. The extracted FE material is then deposited into the FE storage bin 314. In one embodiment, the FE material in the FE storage bin 314 is transferred (e.g. manually, by conveyor, or other means) to the first swivel chute 316. The first swivel chute 316 is operable to distribute the FE material into the exterior FE storage bin 318.

The stream of further shredded material that was not picked up by the second magnetic sorter 312 (“non-FE shredded material”) joins the stream of shredded material that was not picked up by the first magnetic sorter 308. The combined shredded material stream then passes over the screen sorter 320 of FIG. 3B.

FIG. 3B depicts details of stages for sorting materials based on size, weight and/or density, and for separating metal. FIG. 3B depicts various devices, including: a screen sorter 320; a fines storage bin 322; a blower/vacuum sorter 324; a fines storage bin 326; magnetic head pulley sorters 328a-n; a heavies (e.g. wood, other) storage bin 330; a second swivel chute 332; a heavies storage bin 334; and FE storage bins 336a-n.

As shown, the screen sorter 320 is coupled to the fines storage bin 322 and to a blower/vacuum sorter 324. The blower/vacuum sorter 324 is coupled to the fines storage bin 326 and to the magnetic head pulley sorters 328a-n. The magnetic head pulley sorter 328a is coupled to the heavies storage bin 330 and to the FE storage bin 336a. The heavies storage bin 330 is coupled to the second swivel chute 332, which is coupled to the exterior heavies storage bin 334. The magnetic head pulley sorter 328n is coupled to the FE storage bin 336n and to a splitter chute 338 (see FIG. 3C). Material is transported between devices by various means, including conveyors, vibrating conveyors, transportable bins, or other means.

The screen sorter 320 is operable to remove material from the combined shredded material stream that is of an undesirably small size (e.g. “fines”, or residue). This undesirably small material is deposited in the fines storage bin 322. Material collected in the fines storage bin 322 can be transferred or disposed of manually, via a conveyor, or by other means. Elements of the shredded material stream that are large enough to pass over the screen sorter 320 (“overs”) continue on to the blower/vacuum sorter 324.

The blower/vacuum sorter 324 is operable to sort incoming material by weight/density. These materials range in weight from leftover fines (e.g. dust and fragments that did not pass through the screen sorter 320), to light (e.g. foam and fabrics), and to heavy (e.g. wood, cellulose). In one embodiment, the blower/vacuum sorter 324 produces an airstream (“a river of air”) capable of transporting materials of a particular weight/density across a gap (e.g. between two conveyors) while letting heavier/more-dense material fall through the gap (e.g. onto another conveyor).

As the shredded material is released into the air stream, the fine material is sucked up through a vacuum, and collected in the fines storage bin 326. The light materials that are light/less-dense enough to be carried by the air stream are transported by the air-stream to another conveyor that is attached to the magnetic head pulley sorter 328n. Shredded materials that are too heavy/dense to be carried by the air stream (e.g. wood or small bits of metal that may have made it through the previous magnetic sorting stages), will simply fall onto another conveyor that is attached to the magnetic head pulley sorter 328a.

The magnetic head pulley sorters 328a-n are operable to extract remaining amounts of FE material present in the heavy material stream and the light material stream. In one embodiment, each of the magnetic head pulley sorters 328a-n includes a magnetized drum.

As the magnetized drum rotates, any FE material will stick to the drum and be carried to the underside of the conveyor, while any non-FE material will freely fall off the end of the conveyor. As the FE material reaches the bottom of the conveyor FE material is deposited into the FE storage bins 336a-n.

In one embodiment, a conveyor conveys FE material from the FE storage bins 336 to the first swivel chute 316. The first swivel chute 316 is operable to distribute the FE material into the exterior FE storage bin 318. In another embodiment, the FE is conveyed manually to the exterior FE storage bin 318.

Heavy material that escape the magnetic head pulley sorter 328a are deposited in the heavies storage bin 330. The heavy material deposited in the heavies storage bin 330 is transferred (e.g. manually, by conveyor, or other means) to the second swivel chute 332. The second swivel chute 332 is operable to distribute the heavy material into the exterior heavies storage bin 334.

Light material that escaped the magnetic head pulley sorter 328n continue to a splitter shoot 338 shown in FIG. 3C.

Attention is now drawn to FIG. 3C, which depicts details of a stage for sorting light materials. FIG. 3C depicts various devices, including: a splitter chute 338; optical sorters 340a-n; additional optical sorter(s) 342a-n; an HDPE granulator 344; an HDPE storage bin 346; a foam storage bin 348; a quilt storage bin 350; a fabric storage bin 352; reversing conveyors 354; and balers 356.

As shown, the splitter chute 338 is coupled to the n optical sorters 340. The n optical sorters 340 are coupled to the foam storage bin 348 and are additionally coupled to the optical sorter(s) 342a-n. The foam storage bin 348 is coupled to the reversing conveyor 354a. The reversing conveyor 354a is coupled to the balers 356a-n. The optical sorter(s) 342a-n is coupled to the quilt storage bin 350, coupled to the fabric storage bin 352, and coupled to the HDPE granulator 344. The HDPE granulator 344 is coupled to the HDPE storage bin 346. The quilt storage bin 350 is coupled to the reversing conveyor 354b. The reversing conveyor 354b is coupled to the balers 356a-n. The fabric storage bin 352 is coupled to the reversing conveyor 354n. The reversing conveyor 354n is coupled to the balers 356a-n. Material is transported between devices by various means, including conveyors, vibrating conveyors, transportable bins, or other means.

The splitter chute 338 is operable to indiscriminately divide the incoming material stream conveyed from the magnetic head pulley sorter 328n (lights) into n streams of shredded material, where n is equal to the number of optical sorters 340. The optical sorters 340a-n are operable to sort materials of interest present in the incoming material.

Each of the optical sorters 340a-n and the optical sorter(s) 342a-n (“optical sorters”) can be programmed to identify different types of materials. For example, the optical sorters can be programmed to identify polyurethane foam, cotton, or any other materials. The optical sorters can identify materials by their chemical composition, by shape, by size, by color, by spectrophotometric properties and/or by other characteristic as known in the art.

Each of the optical sorters has a plurality of sensors (e.g. 100 sensors) that interrogate the material (e.g. using an IR beam) as the material passes below the sensors on a conveyor. Each of the sensors provides measurements to a machine that controls a plurality of focused air jets positioned at the end of the conveyor. These air jets can be rapidly enabled or disabled. When a piece of material passes under a specific sensor's field of view, the sensor is used to recognize, at a high speed, what that material is and if that material should be ejected from the main material stream onto another conveyor of storage bin. If it is determined that the piece of material should be ejected, as the piece crests over the edge of the conveyor, an air jet will release a quick puff of air to push that specific piece onto one or more other conveyors. The ejected material may be conveyed to a storage bin.

In one embodiment, the optical sorters 340a-n are programmed to eject foam, which is conveyed to the foam storage bin 348. Everything that is not foam is conveyed from the optical sorters 340 to the optical sorter(s) 342a-n. The optical sorter(s) 342a-n are programmed to identify other materials of interest that remain in the shredded material stream. These materials include cotton, quilting, HDPE, or other materials of interest.

In one embodiment, the optical sorter(s) 342a-n sort and separate quilting, fabric and HDPE from the incoming material stream. Quilting removed from the material stream is conveyed to the quilt storage bin 350. Fabric (e.g. cotton) is conveyed to the fabric storage bin 352. HDPE is conveyed to the HDPE granulator 344.

The HDPE granulator 344 is operable to further reduce the size of any extracted HDPE. The granulated HDPE is then conveyed to the HDPE storage bin 346.

In one embodiment, the foam storage bin 348, the quilt storage bin 350, the fabric storage bin 352, and the HDPE storage bin 346 are silos or bunkers with gravity doors. Material deposited on the gravity door of each silo falls through the gravity door into that silo.

The reversing conveyor 354a is operable to convey foam from the foam storage bin 348 to one of the balers 356. The reversing conveyor 354b is operable to convey quilting from the quilt storage bin 350 to one of the balers 356. The reversing conveyor 354n is operable to convey fabric from the fabric storage bin 352 to one of the balers 356.

The balers 356 are operable to compress incoming material into a condensed form. In one embodiment, the balers 356 are open-end auto-tie balers. These balers are operable to bale “high memory” material such as polyurethane foam or the pillow-top of a mattress. The baler compresses material into dense bales that are automatic tied with ties around the perimeter of the bale to prevent expansion of the material. In one embodiment, the ties are metal ties that are tied in 6 inch increments.

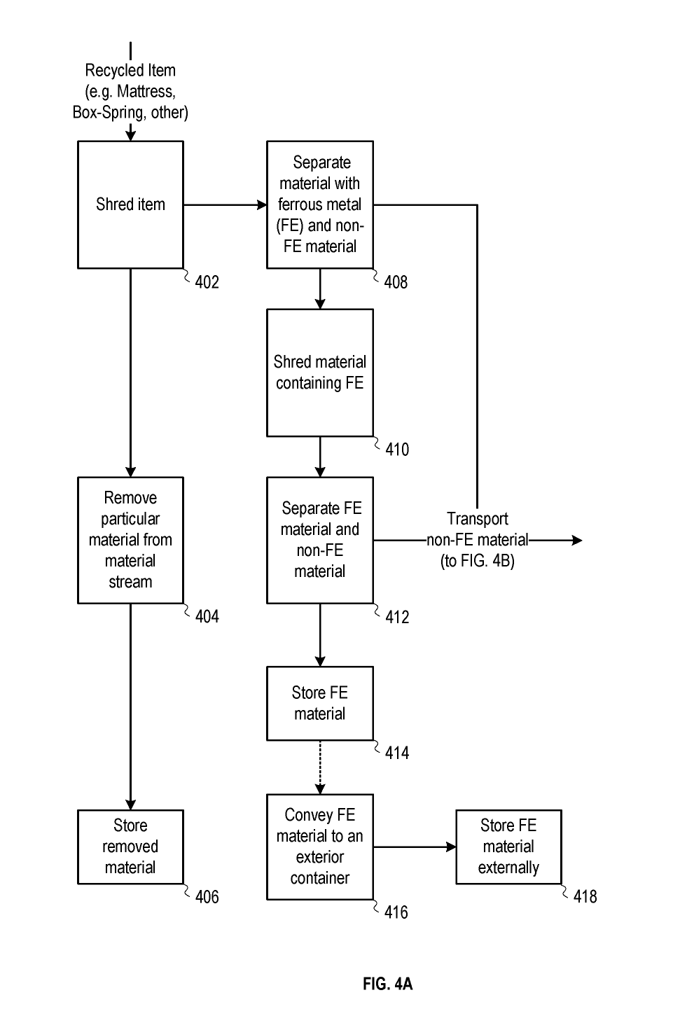

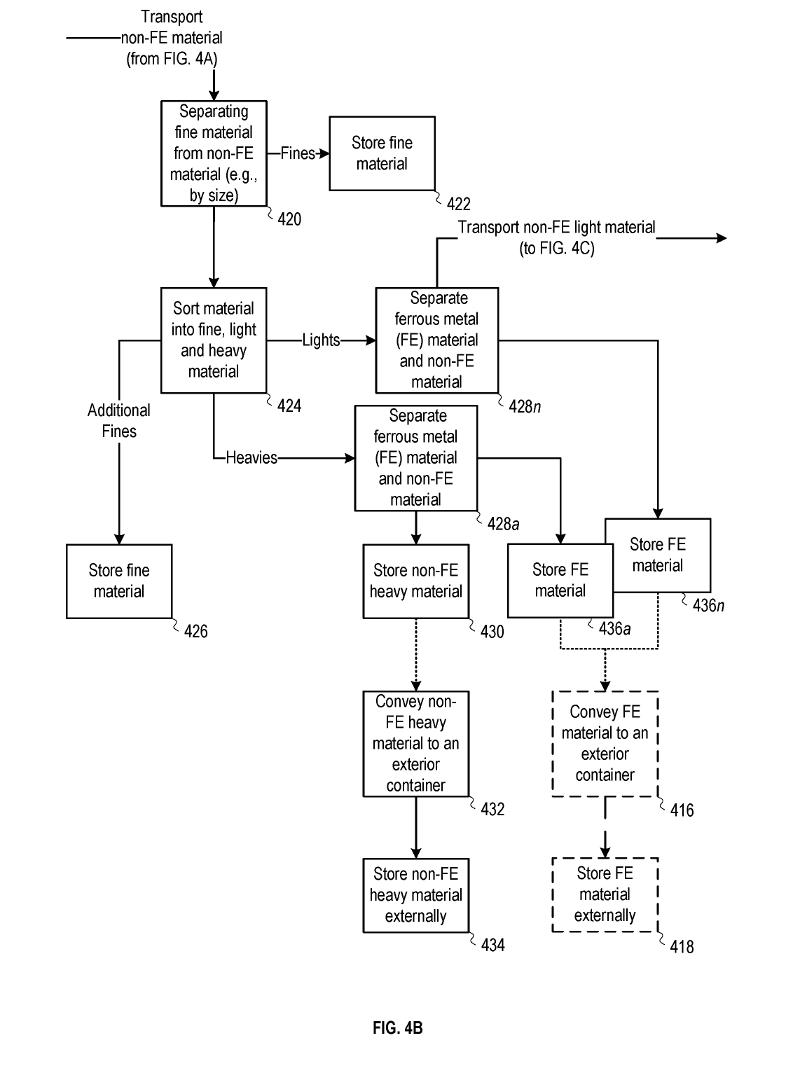

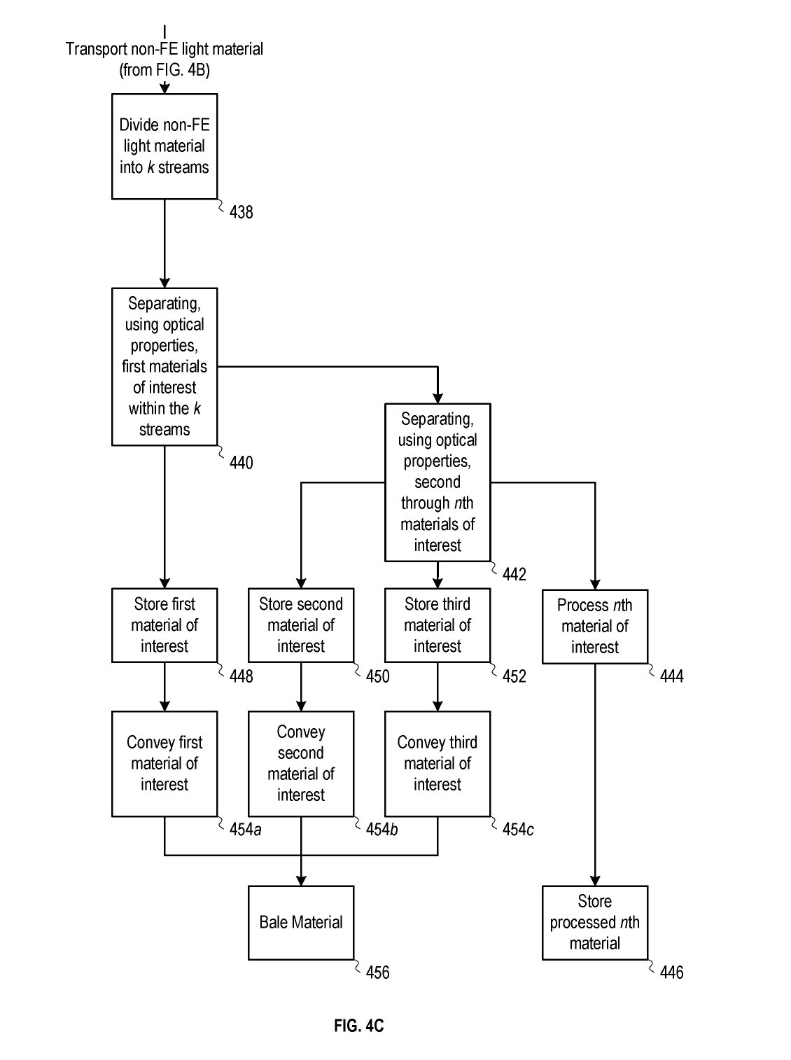

Attention is now drawn to FIG. 4A, FIG. 4B and FIG. 4C, which illustrate different aspects of the process 200 shown in FIG. 2 when the process 200 is used to recycle a mattress and/or box spring. It is noted that different embodiments of FIG. 2 need not use each aspect shown in FIG. 4A, FIG. 4B and FIG. 4C.

FIG. 4A illustrates functional details of a process for material shredding and metal separation. The steps of the process include: shredding or otherwise separating incoming item(s) into strips or pieces of material (step 402); removing particular material from the material stream (step 404); storing the removed material (step 406); separating material containing ferrous metal (FE) and non-FE material (step 408); shredding or otherwise separating the material containing FE (step 410); separating ferrous metal (FE) material and non-FE material from the material shredded in step 410 (step 412); storing the separated FE material (step 414); conveying the stored FE material to an exterior container (step 416); and storing the FE material externally (step 418). Non-FE material separated at step 408 and separated at step 412 is processed at step 420 (see FIG. 4B).

FIG. 4B illustrates functional details of a process for size, weight and/or density sorting. The steps of the process include: separating fine material from the incoming non-FE material (e.g. by size) (step 420); storing the fine material (step 422); sorting remaining non-FE material into leftover fine material, light material, and heavy material (step 424); storing the leftover fine material (step 426); separating the heavy material into ferrous metal (FE) material and non-FE heavy material (step 428a); separating the light material into ferrous metal (FE) material and non-FE light material (step 428n); storing the non-FE heavy material (step 430); conveying the non-FE heavy material to an exterior container (step 432); storing the non-FE heavy material externally (step 434); storing FE identified from the heavy material (step 436a); storing FE identified from the light material (step 436n); conveying the stored FE material to an exterior container (step 416 of FIG. 4A); and storing the FE material in the exterior container (step 418 of FIG. 4A). Non-FE light material is processed at step 438 (see FIG. 4C).

FIG. 4C illustrates functional details of a process for light material sorting. The steps of the process include: dividing the non-FE light material into k streams of material (step 438); separating, using optical properties, first light materials of interest within the k streams of material (step 440); separating, using optical properties, second through nth light materials of interest (step 442); processing the nth light material of interest (step 444); storing the processed nth light material (step 446); storing the first light material of interest (step 448); storing the second light material of interest (step 450); storing the third light material of interest (step 452); storing other light materials of interest (not shown); conveying the first light material of interest (step 454a); conveying the second light material of interest (step 454b); conveying the third light material of interest (step 454c); and baling the light materials of interest (step 456). Optical properties used to separate materials may include chemical composition, shape, size, color, spectrophotometric properties and/or other optical characteristics of materials as known in the art.

### Examples of Materials of Interest

In some embodiments, the systems depicted in FIG. 1, FIG. 3A, FIG. 3B and FIG. 3C, as well as the processes illustrated in FIG. 2, FIG. 4A, FIG. 4B and FIG. 4C, can process portion(s) of a mattress and/or box-spring to extract materials of interest (“extracted material”). By way of example, extracted material may include: materials that were previously injection molded, extruded, thermo-formed or otherwise formed using conventional processing to fabricate one or more structural, functional, and/or esthetic features of the mattress or box-spring; plant-derived cellulosic materials such as wood, cork, cardboard, and/or a wood-based composite material; chemical materials like polymer or polymer-composite-based materials, foamed polymers (e.g. sponge rubber, silicone, polyurethane foam, latex foam, or other visco-elastic foam), elastomer polymers (e.g. rubber or silicone), homopolymers, copolymers, polyester, epoxies, epoxides thermosetting polymer, any other polymers, or mixtures thereof; a butyl rubber, silicone rubber, a fluorosilicone, chloroprene rubber, nitrile rubber, or other rubbers; a filler material that can be oriented in a certain direction and that is at least partially dispersed, and that can be a fibrous material, amorphous or crystalline, organic or inorganic material with a particle size between 1-10 microns, or have a sub-micron/nano size; metal such as copper, stainless steel, aluminum or aluminum alloy, tin, nickel, brass, copper-alloy, lead, or others; fabrics like cotton, wool, or other; and animal-based material like leather, suede or others.

### Other Features

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency.

Functionality and operation disclosed herein may be embodied as one or more methods implemented in whole or in part, and at one or more locations, by machine(s)—e.g. modules, devices, processor(s), or other suitable means known in the art. Non-transitory machine-readable media embodying program instructions adapted to be executed to implement the above method(s) are also contemplated. Execution of the program instructions by one or more processors cause the processors to carry out the method(s) or cause the processors to control system modules or devices to carry out the methods. Machine-readable media may include non-volatile or volatile storage media, removable or non-removable media, integrated circuit media, magnetic storage media, optical storage media, or any other storage media. As used herein, machine-readable media includes all forms of statutory machine-readable media, but not non-statutory machine-readable media.

Systems operable to implement the method(s) are also contemplated. Such systems may include the modules and/or devices described herein or other suitable means.

When two things (e.g., modules or other features) are “coupled to” each other, those two things may be directly connected together (e.g., shown by a line connecting the two things in the drawings), or separated by one or more intervening things. Where no lines and intervening things connect two particular things, coupling of those things is contemplated unless otherwise stated. Where an output of one thing and an input of another thing are coupled to each other, an object sent from the output is received by the input even if the object passes through one or more intermediate things

The words comprise, comprising, include, including and the like are to be construed in an inclusive sense (i.e. not limited to) as opposed to an exclusive sense (i.e. consisting only of). Words using the singular or plural number also include the plural or singular number, respectively. The word or and the word and, as used in the Detailed Description, cover any of the items or all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

### Related Applications

This application relates to the following related application(s): U.S. Pat. Appl. No. 62/201,286, filed 5 Aug. 2015, entitled MATTRESS RECYCLING SYSTEM AND METHOD. The content of the related application(s) is hereby incorporated by reference herein in its entirety.

1. A method for liberating and sorting materials of interest from an item, the method comprising:
separating shredded material of an item into shredded material that contains ferrous metal, and remaining shredded material;
sorting the remaining shredded material into fine material, light material, and heavy material;
separating the heavy material into heavy material that contains ferrous metal, and remaining heavy material;
separating the light material into light material that contains ferrous metal, and remaining light material; and
sorting the remaining light material into at least a first type of remaining light material, and a second type of remaining light material.

2. The method of claim 1, wherein separating shredded material of an item into shredded material that contains ferrous metal, and remaining shredded material comprises:
shredding the item into the shredded material;
separating the shredded material into a first amount of shredded material that contains ferrous metal, and a first amount of remaining shredded material;
shredding the first amount of shredded material that contains ferrous metal; and
separating the shredded first amount of shredded material that contains ferrous metal into a second amount of shredded material that contains ferrous metal, and a second amount of remaining shredded material,
wherein the shredded material that contains ferrous metal includes the second amount of shredded material that contains ferrous metal, and
wherein the remaining shredded material includes the first amount of remaining shredded material and the second amount of remaining shredded material.

3. The method of claim 2, wherein the method comprises:
using one or more magnetic sorter devices to separate the shredded material into the first amount of shredded material that contains ferrous metal, and the first amount of remaining shredded material, and to separate the shredded first amount of shredded material that contains ferrous metal into the second amount of shredded material that contains ferrous metal, and the second amount of remaining shredded material

4. The method of claim 1, wherein sorting the remaining shredded material into fine material, light material, and heavy material comprises:
separating the remaining shredded material into a first amount of fine material, and remaining material; and
separating the remaining material into a second amount of fine material, the light material, and the heavy material,
wherein the fine material includes the first amount of fine material and the second amount of fine material.

5. The method of claim 4, wherein the method comprises:
using a screen sorter device to separate the remaining shredded material into the first amount of fine material and the remaining material; and
using a blower and/or vacuum device to separate the remaining material into the second amount of fine material, the light material, and the heavy material.

6. The method of claim 4,
wherein the remaining shredded material is separated into the first amount of fine material and the remaining material based on the relative sizes of the first amount of fine material and the remaining material; and
wherein the remaining material is separated into the second amount of fine material, the light material, and the heavy material based on the relative weights or densities of the second amount of fine material, the light material, and the heavy material.

7. The method of claim 1, wherein the method comprises:
using a magnetic head pulley sorter device to separate the heavy material into the heavy material that contains ferrous metal, and the remaining heavy material.

8. The method of claim 1, wherein the method comprises:
using a magnetic head pulley sorter device to separate the light material into the light material that contains ferrous metal, and the remaining light material.

9. The method of claim 1, wherein sorting the remaining light material into at least a first type of remaining light material, and a second type of remaining light material comprises:
dividing the remaining light material into two or more streams of material; and
separating, from the two or more material streams, the first type of remaining light material from the second type of remaining light material in the remaining light material using one or more optical properties of the first type of remaining light material.

10. The method of claim 9, wherein the one or more optical properties of the first type of remaining light material include one or more of a shape, a size, a color, or a refractive index of the first type of remaining light material.

11. The method of claim 9, wherein the second type of remaining light material includes two or more light materials, and wherein the method comprises:
separating, from the second type of remaining light material, the two or more light materials;
storing a first light material of the two or more light materials;
granulating a second light material of the two or more light materials; and
storing the granulated second light material.

12. The method of claim 1, the method comprising:
storing each of the shredded material that contains ferrous metal, the heavy material that contains ferrous metal, and the light material that contains ferrous metal in the same or different storage containers; and
storing each of the fine material, the remaining heavy material, the first type of remaining light material, and the second type of remaining light material in different storage containers.

13. The method of claim 1 wherein the fine material weighs less than the light material, the light material weighs less than the heavy material, and wherein the fine material is smaller than both the light material and the heavy material.

14. The method of claim 1, wherein the first type of remaining light material includes foam, and wherein the second type of remaining light material includes HDPE.

15. A system for liberating and sorting materials of interest from an item, the system comprising:
a shredding and ferrous metal material separating module;
a size-based, weight-based or density-based sorting module;
a ferrous metal material separation module; and
an optical sorting module,
wherein an output of the shredding and ferrous metal material separating module is coupled to an input of the size-based, weight-based or density-based sorting module,
wherein an output of the size-based, weight-based or density-based sorting module is coupled to an input of the ferrous metal material separation module, and
wherein an output of the ferrous metal material separation module is coupled to an input of the optical sorting module.

16. The system of claim 15,
wherein the shredding and ferrous metal material separating module includes one or more shredder devices and one or more magnetic sorter devices,
wherein the size-based, weight-based or density-based sorting module includes a screen sorter device and a blower or vacuum device,
wherein the ferrous metal material separation module includes one or more magnetic head pulley sorter devices, and
wherein the optical sorting module includes one or more optical sorter devices.

17. The system of claim 16, the system comprising:
a first shredder device of the one or more shredder devices;
a first magnetic sorter device of the one or more magnetic sorter devices;
a second shredder device of the one or more shredder devices;
a second magnetic sorter device of the one or more magnetic sorter devices;
the screen sorter device;
the blower or vacuum device;
a first magnetic head pulley sorter device of the one or more magnetic head pulley sorter devices;
a second magnetic head pulley sorter device of the one or more magnetic head pulley sorter devices; and
the one or more optical sorter devices,
wherein the first shredder device is coupled to the first magnetic sorter device,
wherein the second shredder device is coupled to the first magnetic sorter device and the second magnetic sorter device,
wherein the first magnetic sorter device and the second magnetic sorter device are both coupled to the screen sorter device,
wherein the screen sorter device is coupled to the blower or vacuum device,
wherein the blower or vacuum device is coupled to the first magnetic head pulley sorter device and to the second magnetic head pulley sorter device, and
wherein the first magnetic head pulley sorter device is coupled to the one or more optical sorter devices.

18. The system of claim 17, the system further comprising:
an high-density polyethylene (HDPE) granulator coupled to at least one of the one or more optical sorter devices.

19. The system of claim 15, the system further comprising:
one or more ferrous metal material storage modules;
one or more fine material storage modules;
one or more heavy material storage modules; and
one or more light material storage modules that include at least one of a foam storage module, a quilt storage module, a fabric storage module, or a high-density polyethylene (HDPE) storage module.

20. One or more non-transitory machine readable media embodying program instructions adapted to be executed to implement the method of claim 1.
